(19) United States
(12) Patent Application Publication
(10) Pub. No.: US 2017/0178208 A9
(43) Pub. Date: Jun. 22, 2017

(54) System and Method for Automated Collections of Debts for Businesses

(71) Applicants: Ahmed Farouk Shaaban, South Barrington, IL (US); Venkat Thandra, South Barrington, IL (US)

(72) Inventors: Ahmed Farouk Shaaban, South Barrington, IL (US); Venkat Thandra, South Barrington, IL (US)

(21) Appl. No.: 14/756,617

(22) Filed: Jun. 30, 2015

Related U.S. Application Data
(60) Provisional application No. 61/998,577, filed on Jun. 30, 2014.

(51) Int. Cl. G06Q 30/04; G06Q 40/02

(52) U.S. Cl. CPC G06Q 30/04; G06Q 40/02

(57) ABSTRACT

The present invention consists of a Billing and Collections System wherein the company or firm may creates an online billing account for each client, wherein the System receives payments from clients and matches the payments to client's account. The client is able to manage the way in which it is billed by selecting one or more of the following: language for billing, currency desired for payment, an exchange rate table preferred by the user for foreign currency payments and the amount and manner of late payment reminders. The System uses the client information from the client's payment in order to identify overdue payments. If the client is overdue, the System automatically sends out dunning communications after preselected periods of time and by preselected methods chosen by the firm or company. The System automatically allocates client payments to various accounting and tax categories in accordance with the tax laws of the respective office's jurisdiction.

### PRIORITY CLAIM

The present application herewith claims priority of Provisional App. No. 61/998,577, which was filed Jun. 30, 2014, and shall be considered as if fully set forth herein.

### FIELD OF THE INVENTION

The present invention relates to the field of automated collecting of billed time to clients, especially those in the professional services marketplace.

### BACKGROUND OF THE INVENTION

In the current marketplace, there are a variety of computerized time and billing systems for professional firms. Some of these systems are computer-based while others operate in a cloud-computing environment. These systems, however, are not suited to large firms having a global presence, with multiple offices, which must be linked together for proper billing and financial management. In addition, these are basic programs, which do not contain the most up to date features involving billing and collections. Other numerous and varied disclosures related to billing and collections are also disclosed in the prior art as shown below.

EP 1,145,162 issued to Ashby discloses the use of a System for processing credit applications, financial and insurance services and administrative and management tools. The System generates a price quote for insurance and finance and facilitates line credit application processing. It also performs: inventory, insurance, and purchase tracking, applicant profiling, targeted marketing, customer satisfaction, etc. However, Ashby does not relate to professional timekeeping or billing.

EP Patent No. 1,769,452 issued to Allin discloses the use of a computerized system for residential and commercial construction projects to maintain and disburse construction draws. It can track lien waivers, distribute hundreds of checks to subcontractors each month, track construction change orders, and manage persons involved in each draw. It manages and generates a construction budget and time line.

It also manages payments to material suppliers. It can manage and store the inspection data for each project. It can manage budgets for GC's and the subs and control ACH payments.

EP Patent No. 2,026,222 issued to Alquier discloses the use of a system and method, which allows the addition, modification and deletion of database fields without the use of a data base administrator. The system allows the addition and modification of an informational structure dynamically distributed directly via the user interface. It supports different types of entity attributes including, text, numerical information, date and time, predefined values and binary objects, allows the creation of relational dependencies between information entities (e.g., patent/child), provides flexible reporting capabilities including spreadsheets, slides, documents, timelines, etc.; it allows a configurable data entry interface, importation of data from external sources, full text searches, logs modifications for an audit trial, and includes email notifications. It allows for a user interface that is flexible and configurable. However, it is not directed toward time tracking and billing generation.

U.S. Patent Disclosure No. 2003/0120538 filed by Boerke, et al. discloses the use of a method for tracking progress on a task by dividing the subtasks to be completed during each timeslot. For example, the time slots may be divided into 15-minute increments. The system only tracks the number of subtasks completed for each timeslot. The method also keeps track statistically of variances in subtasks completed between workers. The process may be used for planning purposes, which helps a supervisor correct negative variances in worker performance. The progress can be logged into a computer or worksheet or in paper format. Problems are also noted by the method for correction to improve performance by variance cards.

U.S. Patent Disclosure No. 2013/00090968 filed by Borza, discloses the use of an employee management and scheduling method directed to ensure that adequate personnel are present as required and that statutory requirements are met and costs are tracked and minimized. Scheduling software is used to manage multiple employees at multiple locations. From one screen, a manager may create, edit and delete shifts and also have access to other aspects of managing the organization staffing with Information about positions, teams, skills, etc. being provided. The System can print Shift Assignment Reports and Employee Reports. However, this disclosure is directed toward scheduling employees and not tracking their time or billing for their time.

U.S. Patent Disclosure No. 2012/0233044 filed by Burger, et al., discloses the use of a Method and System for labor project management and costing which may run on a cell phone app to monitor employee activity, identify faulty activity and manage allocation of labor resources. The system can be used to monitor managers and administrators as well as employees. The system can be used to transmit payroll information. A flag may be generated if the worker travels outside the permissible areas allocated to his role. The system stores employee photos, job locations, routes, job codes, SIC codes, etc. may be entered into the back end by an administrator. The system also generates reports, and has a “Dashboard” or summary report simply show who is on the job, what time they arrived and GPS confirmation of location. The app will operate with a web browser, WI-Fi or on GPS authentication. The system essentially operates as a time tracking system for job sites. The system stores time photos of the employees at check in and check out. The system also records a job number, a job phase and a cost code and also has a payroll calculator communicating with a payroll service.

U.S. Patent Disclosure No. 2014/0258057 filed by Chen discloses the use of a system and method for tracking the User's time of a mobile device for the purpose of billing clients. The system is provided with a digital timer, which is launched at the time of arrival and then stopped when the employee leaves, tracks time sending texts and emails. Time is recorded as soon as the professional receives a voice mail, phone call, text or email. The user can also input notes with the system's time recording and entry. The app automatically looks up in the user's contacts list whether the call or email or text coming in is from a client, and if so, it begins to track it for billing purposes. If not in the contacts registry, the user is alerted and can add the contact as a client to be billed.

U.S. Patent Disclosure No. 2013/0290154 filed by Cherry, et al. discloses the use of the system and method to manage employees at a plurality of job sites by providing a database wherein a set of job site data is stored therein. Employee devices may collect a set of time punch data and photos to store in the system. Management apps are used on supervisory devices to monitor the job site data and employees and validate photos and activate employee apps. The app will operate with a web browser, WI-Fi or on GPS authentication. The system essentially operates as a time tracking system for job sites. The system stores time photos of the employees at check in and check out. The system also records a job number, a job phase and a cost code has a payroll calculator communicating with a payroll service.

U.S. Patent Disclosure No. 2001/0042032 filed by Chrawshaw discloses the use of a system for capturing, processing and reporting time and expense data which can include flat fee billing, maximum fee billing and will allow for discounts and write-offs. A client will not have access to internal data of the company. The system will produce bills, expense reports, time sheets, proposals and project tracking. This appears to be a conventional program for law firm data, which is run on a local server for one location.

U.S. Pat. No. 6,038,547 issued to Casto discloses the use of a construction tracking and payment system for use by contractors and subcontractors so that work may be tracked and payment may be timely made after the work is completed and inspections performed. The system may be implemented on a handheld computer. The system will break down a construction job into various elements, and then a contractor or subcontractor will be given a copy of how the site is partitioned, then each contractor or sub is responsible for submitting applications using the partitioning to ensure uniformity the architect desires to impose.

U.S. Pat. No. 6,747,679 issued to Finch, II, et al. discloses the use of a time keeping and expense tracking server including a server that implements computer instructions that define logic for building GUI screens according to user Instructions. The user can Implement and design the screens needed for the tasks of time keeping and expense tracking. The system may be Implemented on the cloud or Internet with a laptop or wireless device desired. The GUI screen may be customized on a company-by-company basis, a department-by-department basis, etc. The system also includes security wherein projects and projects are only viewable by certain level employees.

U.S. Pat. No. 7,343,316 issued to Goto, et al. discloses the use of a network based shift-scheduling system for generating temporary shift workers. It is sent over portable terminals over a network. The system is set to secure and provide work for a plurality of workers. Workers can also submit cancellations or shift changes via the system. The system also accommodates email for communication purposes. The system may also recruit new employees. The system stores the name, age, sex, address, mail address and qualifications of the employee, the workable time slots, the type of Job, hourly wage, etc.

WPO 2014/016796 filed by Gupta, et al. discloses the use of a system and method for employee tracking in a mobile communication device wherein dynamic location reports may be generated in real time or near real time. The system is directed to door-to-door delivery or pickup sales forces. The System uses a mobile app on the employee's cell phone to conduct the tracking of the employee. The system will raise flags if deviations from tracking occur. The system uses Blue Dophil software to analyze where employees should be performing tasks and produces flags when parameters gathered fall outside permissible ranges. These flags are sent to management via text or email.

U.S. Pat. No. 6,832,176 issued to Hartigan, et al. discloses the use of a method and system for tracking and reporting time spent on tasks in different application on the end users' computers while the tasks are being performed. It may track the opening and closing of files automatically and send reports and messages directly to and from other applications. The software may also suggest categories for each task based upon at least one criteria. The system may use MS Outlook for assistance in tracking tasks and transmitting reports. It is directed toward attorneys and accountants. The system may track fixed fees and use data collected for evaluating production or sweat equity bonuses to employees. The system may track a plurality of projects or research endeavors. It can track the time spent by accountants on spreadsheets. It can track the time engineers spend on designing computer code or simulating circuit designs, etc.

WPO Patent Disclosure No. 2015/079776 to Hishiki discloses the use of a work state management system that manages clock in times for drivers of vehicles that work overnight shifts and calculates the appropriate breaks for the driver so that the driver is not overtired.

U.S. Patent Disclosure No. 2014/0344, 122 filed by Hodgin, discloses the use for billing for time spent in an IM session by a service person wherein the system can automatically bill a project/client by searching for the name of the client or project within a text or Instant message or a series or session of same. If the system cannot find the name of a client or project, then the user will associate the IM session with a new project or client so that the client may be billed for the IM session with the client. Or the System may default into a common template for the User's typical instant messaging sessions.

U.S. Patent Disclosure No. 2009/0006228 filed by Hodgin discloses the use of a time tracking system and method similar to the IM system noted above by Hodgin. The Hodgin system will also store a list of prior associations to Projects and Clients that are built on the same or similar words and phrases.

U.S. Patent Disclosure No. 2002/0154122 filed by Jackson, Jr. discloses the use of an improved system for employers, referral agencies, consultants and independent contractors to hire and manage employees and provide tax reports and wage reports. The Jackson, Jr. System may track and manage employees, salaries and experience to provide optimal benefits to the employer. The System produces computerized scheduling, billing, record keeping and payment templates. It provides a listing of Invoices for the User to refer to, including for contractor services and performs its functions in a cloud-based system.

U.S. Pat. No. 8,838,486 issued to Kong, et al., discloses the use of a time manager interface on a communications display device, allowing a worker to keep track of her or his time and activities. The time manager keeps track of time spent logging into and out of the system. It discloses the use of scanning in employee badges to track work time. This disclosure is directed toward a system for checking work in and work out time. In one version of an embodiment, the System is located in the field. It discloses the use of GPS in the field to create an audit trail of time worked. Biometric information may be used for the system to identify the worker. It can be used nationwide for multiple local offices.

U.S. Patent Disclosure No. 2012/0278211 filed by Loveland discloses a system for remotely tracking and monitoring Workers activities via mobile phones or other mobile tracking devices. This system monitors continuously whether or not a worker is present at a work site.

WPO 2010/11652 filed by Manser discloses a System and Method for tracking employee performance. The Manser system provides a user interface to allow the user to assess the balance of hard skills and soft skills of an employee, evaluate the employee's performance in a plurality of categories and compare the average cost for the job in the marketplace to the cost of the employee being evaluated. The system also analyzes the average cost of a similar job in the relevant marketplace during employee reviews. The program continually monitors the value of an employee to the employer to determine ROI at any given time. The system can be applied to direct hires, contractors, temps or any employee relationship. The system allows the identification of both over achievers and under achievers. The system provides a means by which employees may determine how to get the highest ratings via their work efforts.

EP 2338293 filed by Molotsi discloses a system for time tracking for employers on a mobile computing device. The system involves providing an event manager on a mobile computing device for managing a plurality of events synchronized to a server. The system will automatically track time and estimate time spent on a task by the worker. This system logs events in the user's calendar, in emails and texts. Timestamps for events and mapping for the events are provided. A client list and data may be provided in one or more files or databases. The system may communicate with a worker's smartphone. The user may be able to open, edit, delete, review or manage all automatically created event records. The system may use information in the text, email, and calendar to automatically create a time tracking record for the user. In addition, the system may automatically convert emails, texts, meetings on a calendar to a time tracking event by means of a pop up box to the user.

WPO 2008/061146 filed by Neveu Holdings, LLC discloses a system and method for remote time collection for employee time on job sites. The system can collect an employee's name, picture, title, contact information, health and/or safety information, skill information, etc. The system can also collect for each employee a project name, project identification, location, project start date, project supervisor and detailed comments about project activity. The system can also collect information on vendors, such as name, address, phone, contacts and type of vendor. The system can also use GPS information and compare it with when the employee is supposed to work. Encryption is used to transmit data to and from the remote site. The system may also include a field-scheduling module to schedule a job for a particular job site and for a specific remote user(s).

U.S. Patent Disclosure No. 2015/0081381 filed by Okoba discloses a system and method for recording time, which may be used on a device, software or application. The time recorded may be exchanged for vouchers, which may be redeemed or traded with other members. A user will register with an ID and password to log into the system. The system may record device activity, software activity, application activity, keyboard activity and mouse activity. The user's time spent in the browser or on a video game may be given a redeemable value. A database may store the recorded activity for further analysis.

U.S. Patent Disclosure No. 2015/0081487 filed by Porter, et al., discloses a time tracking and productivity system including a tracking component to locate an employee to record time spent at various locations. This system is designed to monitor and improve coordination of patient care, and in particular, to limit the number of patient hours a resident physician can work per week. When the rules implemented by the ACGME are violated, strict fines and probations or suspension may be implemented. This system is primarily concerned with tracking an employee's location and work hours. It is the movement of an employee within predetermined boundaries that will trigger the recording of a new event. It can track time in a patients room, a brake area, doing paperwork, etc. A GUI is used on handheld devices. The system can also use tags that interact with RF signals. The system records employee info and FRIDA numbers. Automatic warnings of over limit hours are sent to management for the residents via text, phone, email, etc.

U.S. Pat. No. 6,185,514 issued to Skinner discloses a method and system for automatically collecting and analyzing information regarding time and work performed on a computer. It uses a data collector for monitoring certain potions of a worker's computer activity and an analyzer for showing which portions of the activity were continuous work activities, and the system will categorize the work into preset projects and tasks within a project. The system is used to forecast future projects with reduced financial risk. The system includes the automatic documentation of time. The data stored on the system is encrypted so that it cannot be altered by the user. The data collector automatically collects the activity on a mouse and on the keyboard of the computer user. The system creates a log file of work activity. A hardware abstraction layer can interface with phones and other devices and can be used with pointing devices such as a tabled or mouse. The system keeps track of activities multiple open windows on a computer.

U.S. Pat. No. 8,209,243 issued to Smith, et al., discloses the use of a system for performing real time labor management and timesheet reporting which is adapted to wirelessly transmit timesheet Information. The system includes a portable electronic punch system that is capable of communicating with the labor management system via text. The system allows user to manage work schedules and report timesheet Information without requiring an Internet accessible computer. The units send timesheet Information directly to the server for analysis via wireless network. The text messages may contain: employee ID, clock in time, clock out time, breaks, days worked, and other work related Information.

U.S. Pat. No. 9,020,848 issued to Ridge, et al., discloses the use of a method for tracking time and location of an employee according to a predefined schedule and it may utilize software to track the presence or non-presence of: a NFC (near field communication), BLE (Bluetooth Low Energy) or other wireless device. The system will track the presence of an employee in a geo-fenced area. It will also track employee time and other data to log that into a payroll system. The low energy device then communicates data to a server if a signal could or could not be detected. It will also allow for manual clocking in and out in case of failure of the back end server. The system can also be used for security purposes. The system can function in real time or in batch request mode. The information may be a time stamp, a status or location of a mobile device. In one embodiment, the system can be used for employees for a retail store or restaurant. The system can utilize Bluetooth tapping to log in. It may be used at a trade fair both by tapping the device to a NFC communicator.

WPO Disclosure 2015/029073 file by Shirish discloses a system and method to measure aggregate and analyze time, effort and productivity by reviewing time spent on activities such as calls, travel, lab work, meetings, discussions and remote visits. Presence Devices (PD's) may be used to track employee location. The system can track average daily work patterns. It can track work activities and private activities. It can track emails and browsing. It can account for flexible work hours, use of multiple and different types of computing to track effort and performance 24/7. It can provide modules that promote work focus and minimize distraction by awarding performance points, badges for consistent performance and progress in performance goals. It can measure improvement by creating ann-dimensional effort data cube and include analytics for custom reports.

U.S. Pat. No. 2012/0173297 disclosed by Styn, et al., a method and system for task tracking and allocation is disclosed. The disclosure provides for a method in which an individual may create a set of instructions operable to perform a set of tasks in a computer readable medium. That set of tasks may comprise maintaining a database, generating a first interface, displaying subjects associated with individual issues, and a second Interface with notes specific to an issue selected by a user. The Instructions stored in the database may be implemented accordingly and the computer may maintain a plurality of relationship records containing data indicating relationships across folders. This system keeps track of billable items. However, Van Styn is not a true timekeeping and professional billing system.

US Pat. No. 2014/0108644 disclosed by Zaents, et al., a method and system for tracking time in a web-based environment is disclosed. The method of tracking time involves a web-based application to track time associated with several records. Identifying a record in an active state, generating a record associated with the active record and activating a timer, and having the ability to end the session in response to an indication that the record is an inactive state. The time-tracker may be hosted in a cloud-computing environment. The time-tracker may calculate the entire duration of the record by continuously adding the active times together. The method may detect a predetermined total duration of time has been exceeded and provide such indication to user.

However, none of the above patent disclosures teach or suggest improved billing and collections systems which are able to directly edit work-in-progress sheets, draft and final bills and automatically have those changes reflected in the original work data entries. There are also no billing and collections systems seen in the marketplace that can automatically predict cash flow, partner profits and allow clients to view bills in real time. These and other additional objects and advantages are readily derived from the disclosures and drawings provided herein.

### SUMMARY OF THE INVENTION

The present invention consists of Internet and automated based methods and systems for professional services firms, companies, and other business associations which may automate their collections methods to remind clients when payments are due and direct them toward a mobile app or website to log in and pay their account balances. The present inventive system and method also provides for automated means to allocate payments according to a predetermined set of rules, where allocations include: 1) taxes; 2) hard costs, 3) soft costs; 4) professional fees. When a payment is made all relevant data from the payment will be collected, such as name, address, and banking information, which is entered into the System to help the client originator match the payment automatically once payment has been entered. In fact, the System may automatically remind client originators to enter client information of payments, which have already been received by the-System.

When payments are made, the System determines if the client has an outstanding balance and has had sufficient time, typically 7 to 10 calendar days, to review the bill before transferring the payment from a retainer account to the firm's A/R account. The System is able to accommodate payment systems according to business practices around the world. For example, in instances where the payment comes prior to generating an invoice, the payment must be held in a client trust fund account until sufficient time has elapsed between the bill and payment, so that the payment can transferred to the NR (non-resident) account. Another example is in jurisdictions in which firms charge in advance of service and the money is held in an account, in which money is withdrawn when the service is completed. While this is the general rule for law firms, it may not be the case for all businesses. Therefore, in such cases, the user selects whether the company actually has a client trust fund, or if payments are always applied to an NR account from the automated system. Next, the user of the System selects the number of days between receipt of a payment without an invoice or with a recently generated invoice, prior to placing funds in the A/R account, or when to transfer these funds after a predetermined amount of time. Finally, it is up to the client originator to determine when and if funds are transferred. As a result of these variations, payment allocations differ from jurisdiction to jurisdiction and payment allocations are distributed according to each jurisdiction's tax laws.

Next, the System determines how funds received are applied to the firm's NR account according to the jurisdiction or location of the billing office. If a partial payment is received, payment priority rules, which are based on the tax laws of each office, are followed to clear the client's invoice. For example, in certain countries, payments received must be applied to the tax account before being promptly turned over to the taxing authorities. Thus, the System operated in this country would likely allocate payments in the following order: 1. taxes, 2. hard costs, 3. soft costs, and 4. fees. However, this is only one example. The System automatically determines payment allocations according to each office's preference and respective tax laws.

In another exemplary embodiment, the System categorizes the client's debt as personal or business. Based on the client's category, the System will automatically notify the client of the unpaid bill in accordance with the laws set forth by the Fair Debt Collection Practices Act (FDCPA) 15 U.S.C. §1692. In the United States it is important that debt is categorized before any collections efforts are made. When a debt is classified as personal, it is generally categorized as a normal and ordinary household expense, and must be handled according to the FDCPA, which prohibits the creditor from collecting in certain manners by restricting phone calls during certain times, respecting any do not call instructions, and not creating email or other contact lists and requests. In addition, the FDCPA proscribes times and amounts of collections efforts, (i.e. no more than 2 calls per day for a household). The system pings the Federal “Do Not Call” list for phone numbers to exclude from dunning inquiries. On the other hand, if the debt is purely business in character and cannot be categorized as a personal debt, then there is more freedom granted in contacting the debtor because the times and places for collection efforts are broader. In these cases, there the FDCPA is not such a big concern as long as the collections efforts are reasonable and do not amount to harassment, coercion or duress.

In one exemplary embodiment, the System has several sets of books for allocating payments. This is especially important where the client is charged interest after a payment is made later than a specified date. In the case of e-bills, it may be possible to flag the account for interest after 14 days; however, if the bill is transmitted through mail, an additional 5 business days or calendar days are added to the time period before interest begins to run.

For partnership evaluation purposes, the firm may want to recover a proportionate share of hard costs (building, land, inventory, supplies) and charge that against a partner, then recover soft costs (fax, phone, travel, taxi, disbursements to the client). The System assigns a “leverage ratio,” to the partner that represents the value of the client to the firm.

In yet another exemplary embodiment of the present invention, when client payments are timely made, the System applies payments to respective invoices, which meet specific client requirements such as: group (joint) billing, multi-payer billing, fixed fee billing, capped billing, task based billing and e-billing. The System assigns a fee arrangement code to the client's preferred method of billing or according to an attribute of the matter/project (e.g., hourly, fixed/capped, discounted hourly rates, blended rates, banded rates, retainer). Group (joint) billing is a bill that contains multiple matters/projects (engagements) that are grouped together to create a single invoice. The grouping of matters is achieved by a common grouping code (group ID or joint bill ID) on matters/projects and by identifying a lead matter/project. During the billing process, a single Invoice is generated for all the matters/projects with the same group ID. Multi-Payer billing is a payment arrangement with multiple payers. Each payer is responsible for a certain percentage of the invoice amount. This is achieved by assigning multiple payers to a matter/project along with their percentages. The total of the percentages should always equal 100%. The draft and final bill display the total invoice amount and a list of payers, their individual percentages and amounts due.

When the payment is received it is scanned together with the invoice and is automatically applied by the system. If there is no invoice number, the payment will be applied against the client's outstanding balance. In the case of overpayment, an automatic notice will be sent to the client alerting her or him and asking what the preferred payment for the refund is. If the client makes no selection, the overpayment is automatically transferred to an Interest on Lawyer Trust Accounts (IOLTA) or other trust account, with the client's name marked thereupon. For example, if a law firm has received a payment it cannot match to a client, that payment will automatically be placed into an IOLTA account or other trust account until the client has been identified.

The collections system begins when a client is late by a certain number of days in bill payment. The System generates reminder letters for the client to pay the bill according to the pre-determined intervals, which are based according to payment priority. The System produces reports that facilitate collections by showing the most effective means for collecting a particular type of bill. In one preferred embodiment of the present invention, late payments are classified as low priority for those under 30 days late and then move up in priority as more time passes by in the system. In the case that substantial time passes and the bill has not been paid, it will be sent to the litigation department a collections agency, and/or to a credit-reporting agency. These actions flagged with an indictor of when the client matter was completed so that escalation of a billing dispute does not induce the client to file a Bar complaint or malpractice suit because a lawsuit for nonpayment can only be entered after all work is completed.

When the client pays in a different currency than the local currency the client's account is credited according to the prevailing exchange index agreed to between the client and company. The System pings the agreed upon exchange authority Immediately prior to calculating payment and applying it to a client's account, which allows the client to choose from a plurality of websites to optimize exchange rates. The System generates statements of accounts where many of the matters are billed in different currencies. The System also has a threshold where balances will not be billed if they are under a certain nominal amount (e.g., $10 or $25). All write offs will show on the client's permanent file as “courtesy credits.”

The System also provides security levels, in which the client-originating partner or billing partner determine how to contact the client. Some clients may be marked “private and confidential” meaning no one from the firm is allowed to contact the client other than the billing partner. Other clients are marked “immediate staff only”, meaning only the billing partner and his associates and staff can access the clients file. In such cases, the billing department will not contact the client and will issue payment reminders directly to the billing partner, so that the billing partner can contact the client to pay the bill.

Clients can create their own online accounts, complete with various options for client and billing partner information and billing information. If a client chooses a payment plan, a contract will be prepared between the consumer and firm in minutes, complete with an esignature and an email of all terms and conditions. If a client needs a bill generated in a foreign language, the System can automatically provide the bill in the foreign language, because the System is able to produce bill in a plurality of languages.

Clients can also pay by faxing, texting or emailing a check to the firm. The System can automatically capture and recreate a scans of a checks and then submit the payment via overnight ACH (automated clearing house) transfer. The System can also duplicate the check information (sender, sender's address, phone number, check number, amount, bank name, bank address, routing and account number) and transfer the check information to a program that will print the check at the firm for deposit into the firm's IOLTA account or operating account, as determined by the System according to a predetermined set of rules. The System is able to receive and send electronic files to and from the company's bank, wherein the System reconciles bank accounts by checking for direct deposits, wire transfers, PayPal transfers, QuickPay payments, and other electronic payment methods. This information is uploaded into the System, where it is matched to the specified clients account, which has been selected according to a predetermined set of rules.

In addition, when a cash payment or check payment has been received, accounts receivable may log into the System, enter the date, amount and type of payment and then automatically generate a deposit slip if the payment will be personally delivered to a local bank. The System also automatically reconciles bank statements with the company's general ledger, bank ledger or master data and flags any incorrect or missing data.

Another feature of the present inventive System is to automatically provide “courtesy credits” to the client for cooperative efforts in litigation, negotiated flat fees, cash payments (to avoid credit card fees), prepayments and early payments on bills generated by the System. Client cooperation may comprise one or more of the following: cooperating with counsel and staff, attending meetings as required, attending court appearances as required, etc. The System will also revoke courtesy credits upon the following conditions: client late payment, client non-payment, client falls to attend meetings or court when required; client falls to return phone calls, emails, texts, etc. The System also produces online accounts receivables reports to collections staff and billing partners by sorting by invoice, date, client name, billing or originating partner, text, etc. in one line reports which can be seen in detail in a pop out window or PDF as desired.

However, other alterations and configurations commonly known in the prior art should be considered as being part of scope of the present invention as if fully set forth herein. Accordingly, the present invention has been described with various configurations and alterations, which are present in a number of preferred embodiments.

### OBJECTS OF THE INVENTION

It is one primary object of the present invention to provide a billing and client collections system and method wherein a company or firm has an improved method of allocating partial payments according to a predetermined set of rules that allocates payments as follows: 1) taxes; 2) hard costs; 3) soft costs; and 4) professional fees. The purpose of payment allocations is to produce a method to comply with the tax laws in which the system is operated and attribute profits fairly among client originating partners and billing partners in a professional services firm

It is yet an additional primary object of the present invention to provide a system and method which will analyze the accounts receivables of a company or firm and will automatically generate a list of clients that may benefit from a payment plan which takes periodic payments for larger bills while creating additional profits by collecting interest on remaining balances.

It is still a further primary object of the present invention to provide a billing system, which can be triggered to provide an Interim bill before the month's end so that a client may make a payment earlier.

It is an additional primary object of the present invention to provide an Improved billing system which can take preliminary Information from a clients payment, such as from a cash receipt, a bank record of deposit, a bank check, Quick Pay, etc. and place this into a database for unmatched payments to be held in a trust account or an IOLTA account until the payment is matched to a client account and bill.

Still a further primary object of the present Invention is to automatically send daily accounts receivables reports to partners that request these reports.

It is yet an additional primary object of the present invention to produce a report to the client originating partner or his/her client, which consists of all the Invoices and payments associated with the client in order to provide an automatic and accurate accounting that detects missing or misapplied payments.

Yet an additional primary object of the present Invention is to assign billing security levels for the purposes of determining who may contact the client regarding billing and collections matters, which is determined by the billing or client originating partner.

Still an additional primary object of the present invention is to provide the billing partner or client originating partner with means to automatically dun clients who have not paid their bills after a predetermined period of time, set by the contract between the partner and client.

It is an additional primary object of the present Invention for the system to analyze billing activities such as area of law and task, and then categorize the billing client as consumer if the area of law and activity relates to purely consumer based activities for the purposes of determining whether the debt falls under the FDCPA for clients in the US or for purposes of collections strategies.

It is still an additional primary object of the present Invention to ping a national “do not call list” for the purpose of determining whether or not the firm's collections or accounts receivables department is able to call the client to remind her or him of payment.

Yet an additional primary object of the present invention is to allow the client to choose the type of electronic payment and the exchange rate to ping if the client decides to pay with non-local currency.

It is still an additional primary object of the present invention to provide a collections system wherein the firm will choose the number of days between when a client makes a prepayment, the law firm renders a bill, and transfers funds from an IOLTA account or other trust fund account into the firm's operating account.

An additional primary object of the present invention is to provide a-collections system where the firm may decide, after a given period of time of non-payment, to generate a credit agreement and offer the client a payment plan, and have the client sign the agreement either physically or online and return the agreement together with a first payment.

Still a further primary object of the present invention is to provide a collections system, which will automatically produce a bank deposit slip when cash or check payments are logged into the System and the deposits are personally delivered to the bank daily.

Yet an additional primary object of the present invention is to provide a collections system, which will provide courtesy credits to a client for prepayments, early payments, cash payments, client cooperation and other situations, which saves the firm time and trouble in collections.

An additional primary object of the present invention is to provide a collections system which allows the firm's debt to be categorized as low, medium or high priority, where low priority debts are handled with automated fax, email or text friendly reminders for payment, medium priority debts are handled by phone and a request for a payment date, and high priority debts are sent to collections or the litigation department for further review.

Still a further primary object of the present invention is to provide a collections system, which automatically reminds clients to pay by automated fax, email or text at regular intervals, e.g., ten days, twenty days and thirty days later.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a flow chart of the present inventive system, improved billing and collections system.

FIG. 2 is a flow chart of the present inventive system, improved billing and collections system.

FIG. 3 is a flow chart of the present inventive system, improved billing and collections system.

FIG. 4 is a flow chart of the present inventive system, improved billing and collections system.

FIG. 5 is a screen shot of one preferred embodiment of the present invention showing “Payment Process.”

FIG. 6 is a screen shot of one preferred embodiment of the present invention showing the screen for “Post Incoming Payments.”

FIG. 7 is a screen shot of one preferred embodiment of the present invention showing “Post Incoming Payments and Enter Partial Payments.”

FIG. 8 is a screen shot of one preferred embodiment of the present invention showing “Billing and Payment Report.”

FIG. 9 is a screen shot of one preferred embodiment of the present invention showing “Billing and Payment Report”.

FIG. 10 is a screen shot of one preferred embodiment of the present invention showing “Billing and Payment Report” and a drop down menu.

FIG. 11 is a screen shot of one preferred embodiment of the present invention showing “Billing and Payment Report” showing line items.

FIG. 12 is a screen shot of one preferred embodiment of the present invention showing “Billing and Payment Report” showing line items.

FIG. 13 is a screen shot of one preferred embodiment of the present invention showing “Matter Customer Enhancements.”

FIG. 14 is a screen shot of one preferred embodiment of the present invention showing “Project Builder” items.

FIG. 15 is a screen shot of one preferred embodiment of the present invention showing “Project Builder” items.

FIG. 16 is a screen shot of one preferred embodiment of the present invention showing “Project Builder” items.

### DETAILED DESCRIPTION OF THE DRAWINGS

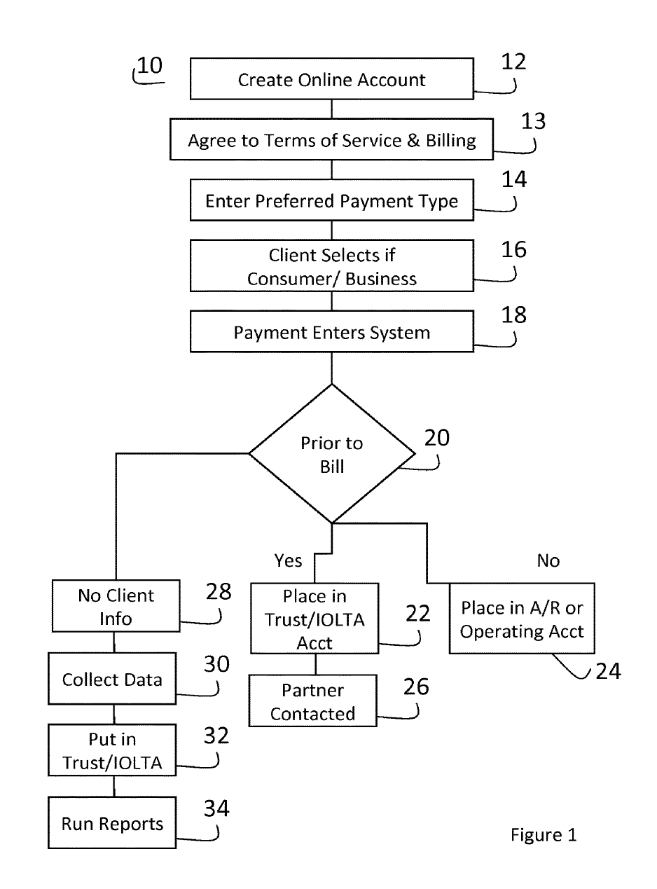

Shown now in FIG. 1 is a flow chart showing Billing and Collections System 10. The process begins with the user creating an online account 12 to access their Information as a client of the firm. The client chooses an ID, password, and agrees to terms of service and billing by the firm 13. The user enters the preferred type of payment and e-invoicing. E-invoicing Includes some or all of the following money types: PayPal, Bitcoin, e-money orders, and bank account information (bank name, routing number and account number). E-invoicing and payment are often preferred for both the consumer and the business because there is little or no float time until money is accessible to the business, and the service is often free or much lower than credit cards. The system also accepts ACH payments from clients in which daily bank account downloads detect and automatically enter information from said ACH payments.

Next, the client or System selects the type of debt, either consumer or business, acquired from the firm 16. The reason for this selection is due to laws, such as the FDCPA, which are generally much tighter when dealing with dunning consumers under the FDCPA whereas collections for a business is much more lenient. However, licensed professionals such as law firms, accounting firms, architectural firms and professional engineering firms still have ethical standards where they are not permitted to dun their clients so frequently because it becomes harassment.

Additionally, in the online account, the client may select from a variety of Internet publications (New York Times, Wall Street Journal, etc.) to optimize exchange rates if paying in a foreign currency. Favorable exchange rates are pinged at anytime prior to payment in order to optimize the exchange rate for the client. Further, the Billing and Collections System 10 allows the client to request a discount on the bill for early payment or prompt payment. The Client will also be allowed to print a report with all invoices and payments by date so that she or he will be able to see if there are any missing payments or if the client did not receive all invoices. The client will set the preferred method of payment reminders when any payment is late (text, phone, fax, email or letter). The firm may also make at least one or two methods mandatory for overdue payments. Billing and Collections System 10 also automatically checks the national “Do Not Call” list before any calls to clients are made. Billing and Collections System 10 will also put a warning on the Client's account that collections phone calls are not welcome.

When a payment enters into the Billing and Collections system 10 it is automatically processed 20. When the payment is received, the System also determines whether the client has an outstanding balance, and if so, it is automatically placed in the company's accounts receivables or operating account 24. If there is not an outstanding balance, the payment is placed in a client trust account or a billing partner's IOLTA account (Interest on Lawyer Trust Accounts) or it may be deposited in another trust account 22. After the payment is made, the billing or originating partner is contacted 26 and is asked if an interim bill may be run immediately so that funds can be deposited in the company's A/R account or operating account as soon as possible 24. The Billing and Collections System 10 will automatically transfer the funds from the IOLTA or firm trust account after a predetermined number of days set by the firm or client to ensure the client has had adequate time to look over and approve the bill.

In addition, payments can be entered 28 even if there is no client information on file. The Billing and Collections System 10 checks for a client name match, if that comes back null, the address, phone numbers, emails and any other data on the payment will be entered into the system for a match 30. If there is still no a match, a temporary client trust account, will be set up until the client's identity can be matched with a bill 32. A periodic report will be emailed to all the partners 34 until the client is claimed and a client information account is properly set up.

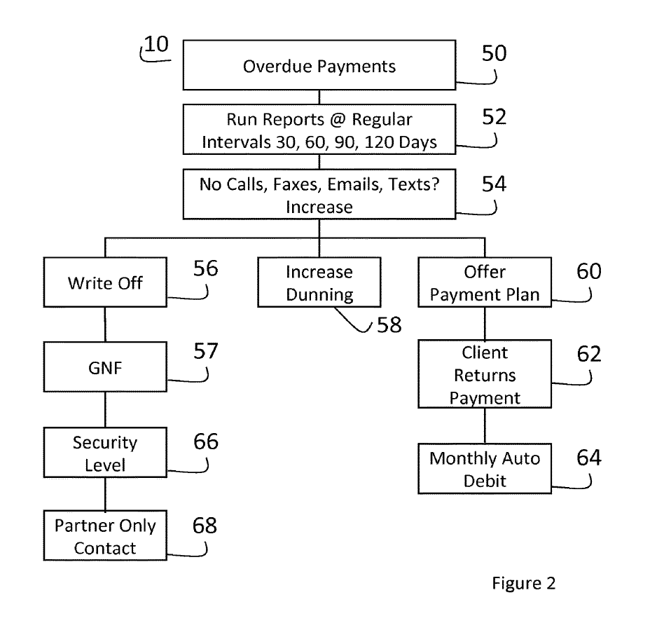

FIG. 2 shows a flow chart for Overdue Payments 50. The Billings and Collections System 10 creates reports for clients that are over 30, 60, 90, 120 days overdue, or according to a timeframe selected by the firm and the billing partner 52. The reports shall indicate the amount overdue, the collections efforts made (number of dunning letters sent, calls, faxes, texts and emails) and whether those efforts were met with any success 54. The billing or client originating partner will be able to increase dunning efforts, or contact the client and ask if the client paid the overdue amount, or write off nominal amount unpaid 56. Or, the billing partner may be asked if he is willing to increase dunning efforts with more letters, calls, faxes, texts and emails 58. Finally, the billing partner will be able to automatically offer the client a payment plan where a credit agreement will be automatically generated by Billing and Collections System 10, and will be sent to the client with a request to make payments of 10, 12, 18 or 20 months to make payment easier for the Client 60. The client will be instructed to return the signed agreement together with a first payment to initiate the agreement 62. The client will be asked if the payment may be automatically deducted from a credit or debit card or a checking account each month. Client entry will be created, but it will not Include the name of the billing partner or client originating partner. The payment will then be placed in an IOLTA account for law or via an Internet e-payment service such as Chase Quick Pay, PayPal, Bitcoin and the like 64.

The Billing and Collections System 10 also provides security levels 66 where a billing or client-originating partner selects whether the billing department can contact-the client regarding billing/collections. Security levels 66 are set up according to the client's confidentiality status. If the client's information is highly confidential, the System will prompt the billing or client-originating partner to contact client regarding overdue payment 68.

Management approves write-offs before they are issued and write-off reports will be sent to management so that write-offs are continuously accounted for 56. GNF reports 57 are also sent out and some collections efforts made as long as the efforts are not outside the statute of limitations for written contracts. The Billing and Collections System 10 is able to differentiate between discretionary write-offs, court ordered write-offs and those used as further inducement to pay an outstanding bill. Billing and Collections 10 regularly analyzes which inducement to pay write-offs are most likely to generate the optimal income to the firm or company.

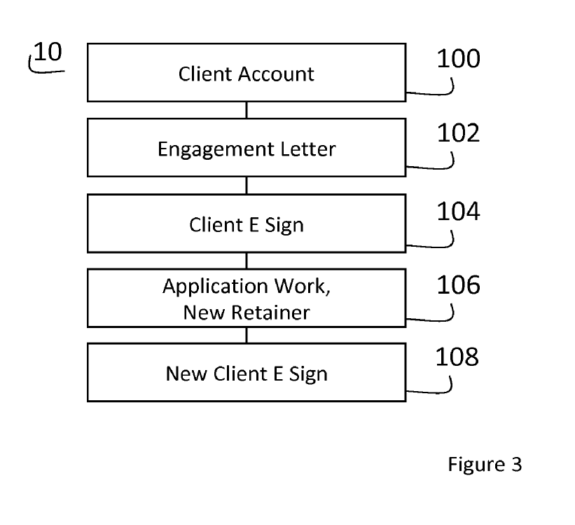

FIG. 3 shows a flow chart when the client's online account 100 is set up for the Client. The Billing and Collections System 10 pings the client-originating partner or billing partner for the preferred type of engagement letter or retainer agreement 102 for the client to review and sign. The System will allow for e-signatures 104 of these agreements after the client has scrolled down and read the agreement. In such a manner, the agreement between the firm and client can be completely flexible and updated easily by the billing or client-originating partner, as the client's needs change from time to time. For example, a client could come to the firm for the execution of a will and trust. A retainer agreement is generated and signed for this work. The client then experiences an accident and decides to use the firm for the accident incident. A second agreement 106 is placed in the Client's online account for a contingency agreement for 33% of all funds recovered. Once the Client hase-signed that agreement 108, the billing or client-originating partner can begin working on that matter.

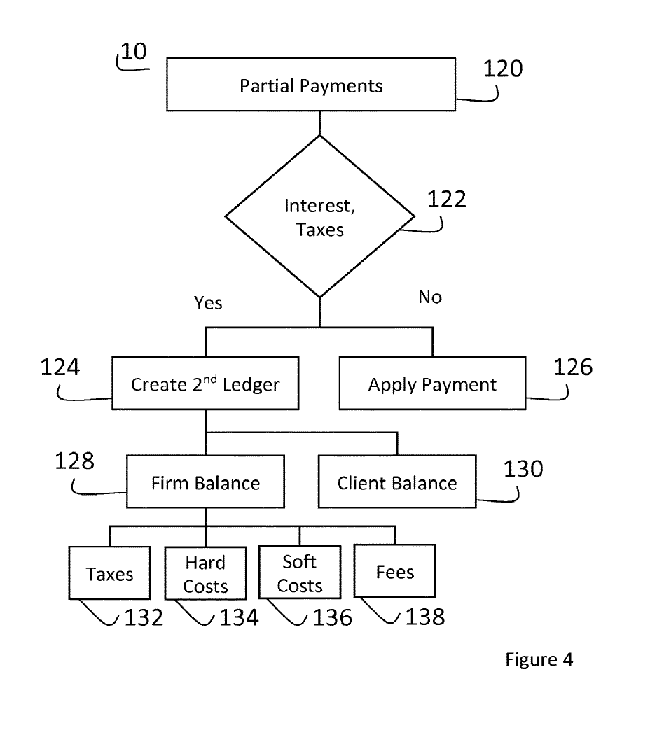

FIG. 4 shows a flow chart for an additional ledger when there is Interest due from a client. In general, when a partial payment is received 120, Billing and Collections System 10 analyze whether there is interest due, and if so, is the jurisdiction a pay taxes first jurisdiction 122. If so, the second ledger 124 will pay or allocate the taxes first, and then the remaining balance will be allocated on the ledger in the following sequence: hard costs, soft costs, professional fees, and profits to the partners. This will leave one firm balance 128, which consists of the subparts taxes 132, hard costs 134, soft costs 136, professional fees 138 paid, and another client balance 130 for the purposes of determining partner profits to be split. If no interest is due, payment is applied 126.

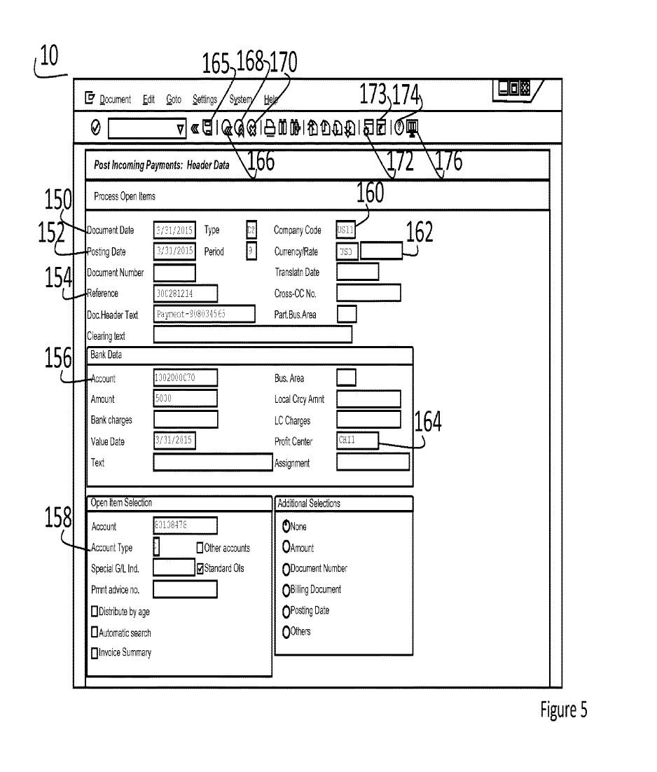

FIG. 5 shows Billings and Collections System 10 with a field for the transaction date 150 or posting date of a payment 152. The user can set a date for posting separately from the transaction date for purposes of tax collections, interest calculations, etc. The Billing and Collections System 10 also shows a field for entry of a check number 154 or authorization number for a credit card or other relevant posting data. It also shows a field for a bank account number 156 (of the company) to be noted where the payment was deposited, in order to keep track of whether the payment was deposited in the firm's operating account for salary payments, disbursements and vendors, or the firm's trust account or IOLTA account. The account number 158 corresponds to the firm's accounting system in which the payment is posted. Also provided is a field for company code 160, currency rate and type (eg, Canadian Dollars and the ratio of Canadian Dollars to US Dollars 162. At the header of the screen shot the following icons are shown: save 165, back or last screen 166, exit screen 168, close application 170, view 172, email 173, help 174, and research 176.

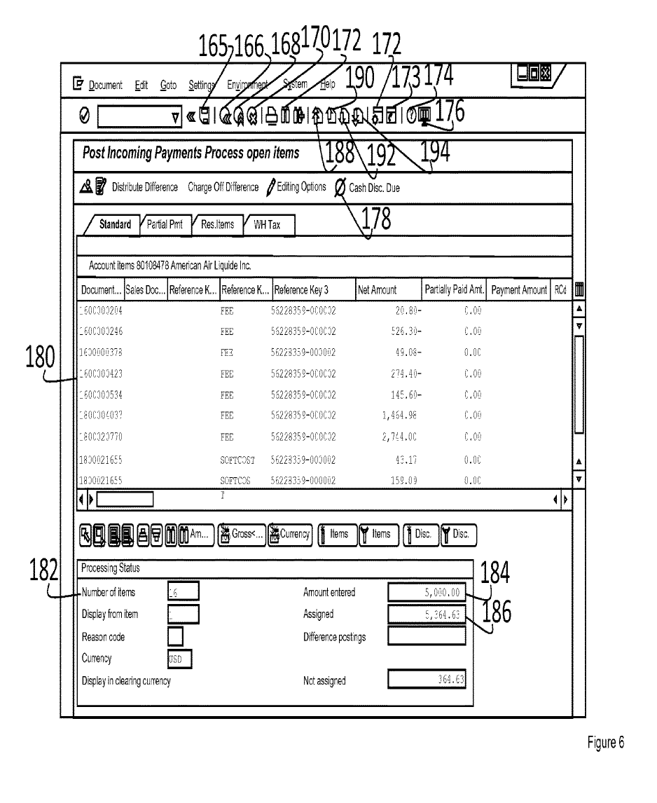

FIG. 6 shows a screen shot of Billing and Collections System 10 when a partial payment has been applied to an invoice. In this figure the following icons are shown: save icon 165 to save payment being entered; last screen icon to go to the last payment entered 166; up screen icon 168; move up icon 170; text payment 172 icon; email payment icon 173; help icon 174; research the internet icon 176; cash discount due icon 178; move to top of list icon 188; move up one in list icon 190; move down one in list icon 192; move to last in list icon 194. The screen shot also shows a plurality of line items of an invoice 180, in which the user may click for further details; the amount entered for the payment 184 and the invoice that the payment was assigned to 186. By using email payment 173 icon and text payment icon 172, the user can select to turn these features on so that a billing partner or other client originating partner can be notified by text or email as soon as a client has made a payment and it has been entered into Billing and Collections System 10.

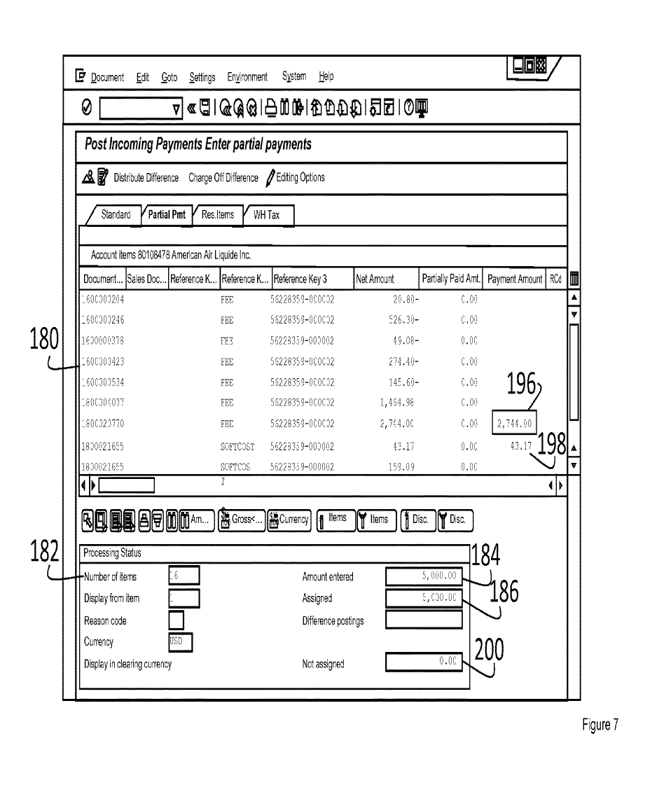

FIG. 7 shows a screen shot Illustrating a preferred embodiment of Billing and Collections System 10 for posting a partial payment to the System. The user has the option to click on two fields: a fee field 196 containing the entry 2,744.00, and a soft cost field 198 containing a fee of 43.17. In addition, the drawing shows the number of items listed 182 as being 16 invoices, and the amount of payment entered 184 as being 5,000.00, and that 5,000.00 was assigned 186 to particular invoices. Also shown the value not assigned 200 showing a value of 0.00.

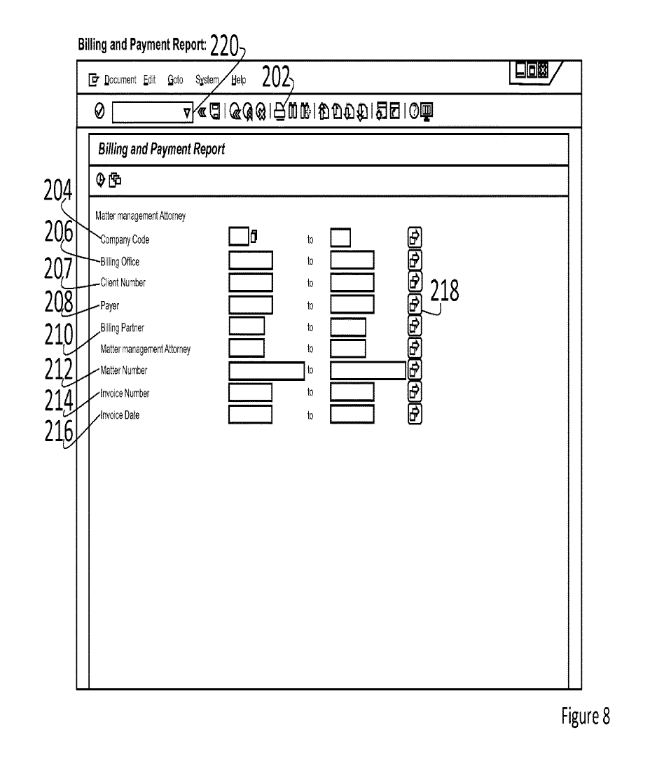

FIG. 8 shows a screen shot of Billing and Collections System 10 for posting a payment and printing billing and payment reports. This screen shot shows: print Icon 202, company code field 204, billing office field 206, client number field 207, payer field 208, billing partner field 210, matter number field 212, invoice number field 214 and invoice date field 216. A series of pop out box icons 218 are provided next to each field so further information in a pop out box or drop down menu may be displayed as requested by the user thereof. A search field 220 is also provided so the user can search all invoices for particular words and phrases. And a print icon 202 is provided for running reports as desired by the user.

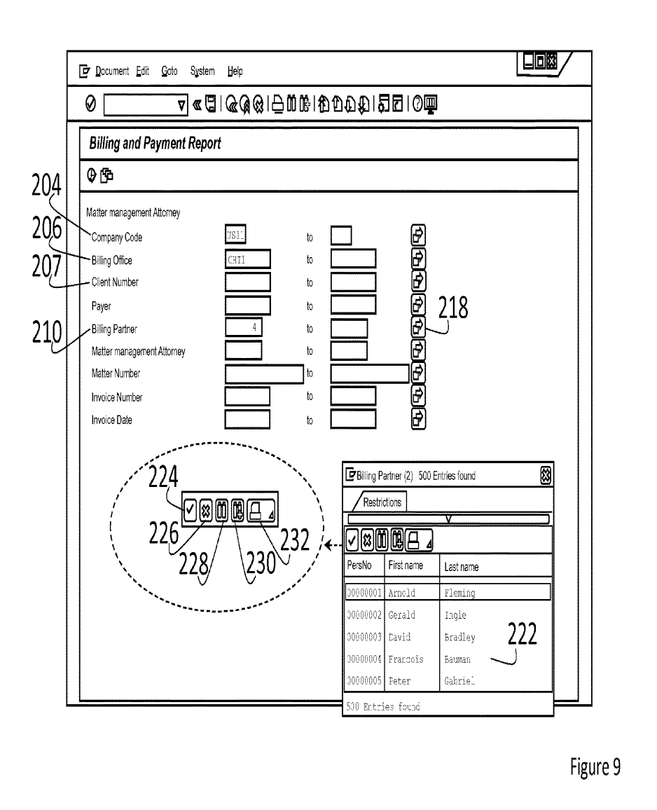

FIG. 9 shows a screen shot illustrating a preferred embodiment of Billing and Collections System 10 wherein the user clicks on the pop out box icon 218 of FIG. 8 for billing partner 210, displaying the following information: select or activate field 224 for selecting partners who will have access to client's billing and collections information as shown in the client number field 207, deselect or deactivate field 226 for deselecting access to billing and collections information, scroll home Icon 228, scroll to right icon 230, print report icon 232 and list of billing or client originating partners 222. In addition, the company code is selected by entering the number in the company code field 204. Billing office field 206 is to select groups of attorneys or staff.

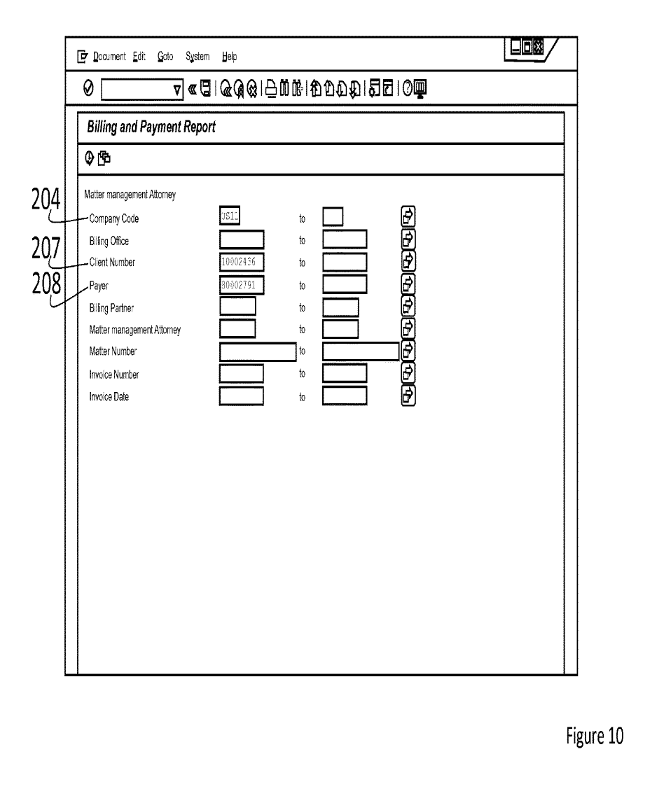

FIG. 10 shows another screen shot of Billing and Collections System 10 wherein the following fields are selected by the user: company code 204, client number 207 and payer 208. A client may have a different payer for his account, or multiple different payers for the client's account. This is often the case where an insurance company has hired an attorney, firm, or groups of attorneys to handle its litigation matters.

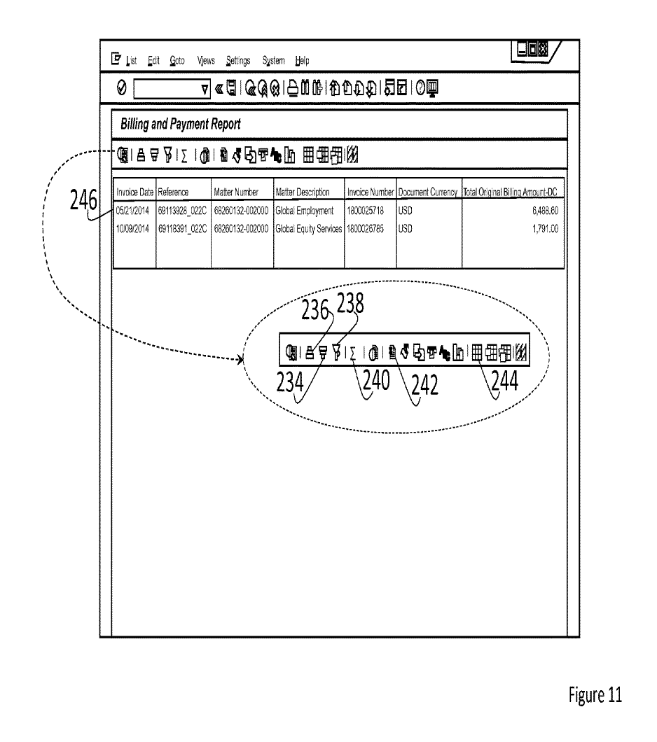

FIG. 11 shows another screen shot illustrating a preferred embodiment of the present invention, Billing and Collections System 10 wherein invoice information is listed 246. Also shown in this screen shot are the following icons: descending sort icon 234, ascending sort icon 236, filter fields icon 238, sum invoices icon 240, download invoices icon 242 and invoice report layout 244. The System is capable of producing a variety of customizable invoice reports by clicking on invoice report layout icon 244.

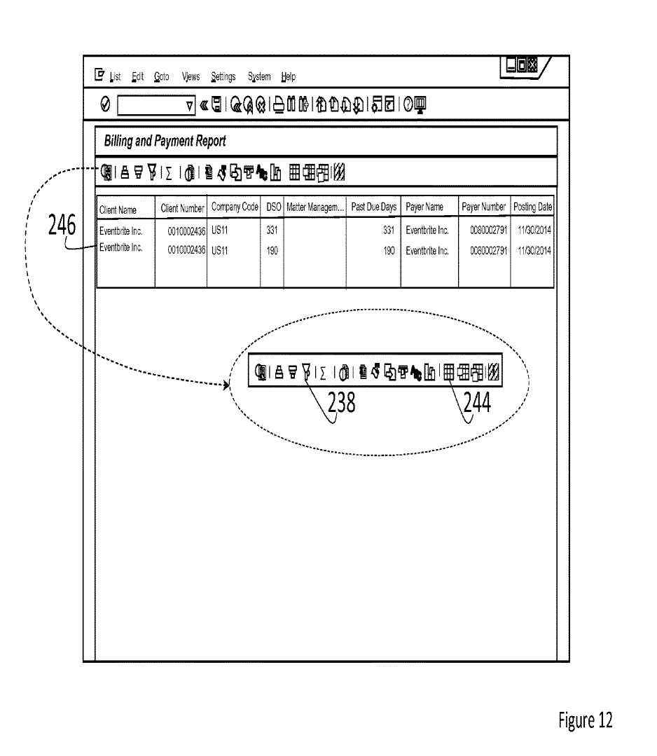

FIG. 12 shows another screen shot illustrating a preferred embodiment of the present invention, Billing and Collections System 10 wherein a billing and payment report includes the following: filter icon 238, report layout icon 244 and line item listing 246 created by selecting the desired report layout and filters.

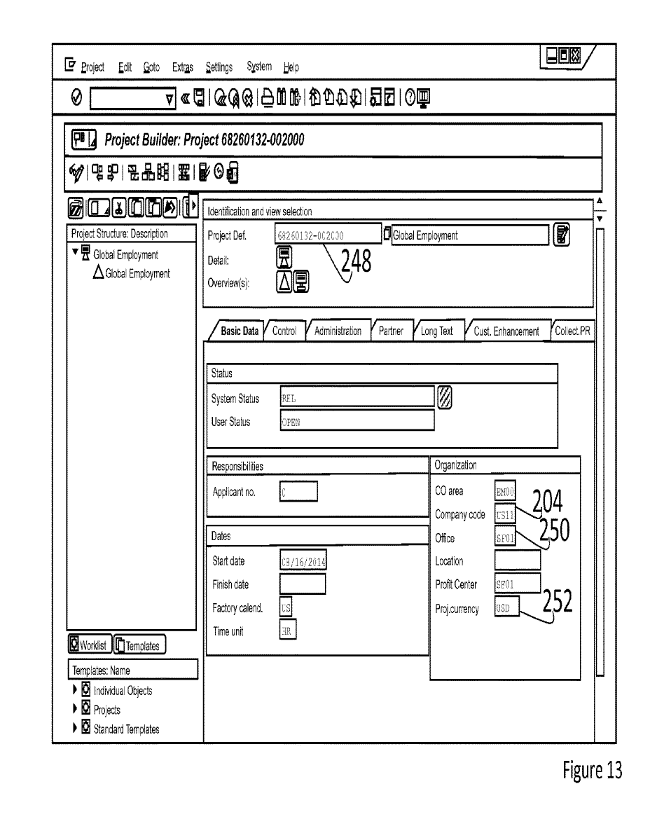

FIG. 13 shows yet another screen shot illustrating a preferred embodiment of the present invention, Billing and Collections System 10 wherein the following is displayed: a project definition field 248, a company code 204 for the project, a local office field 250 designating the location for the project and the currency for the office 252 involved in the project.

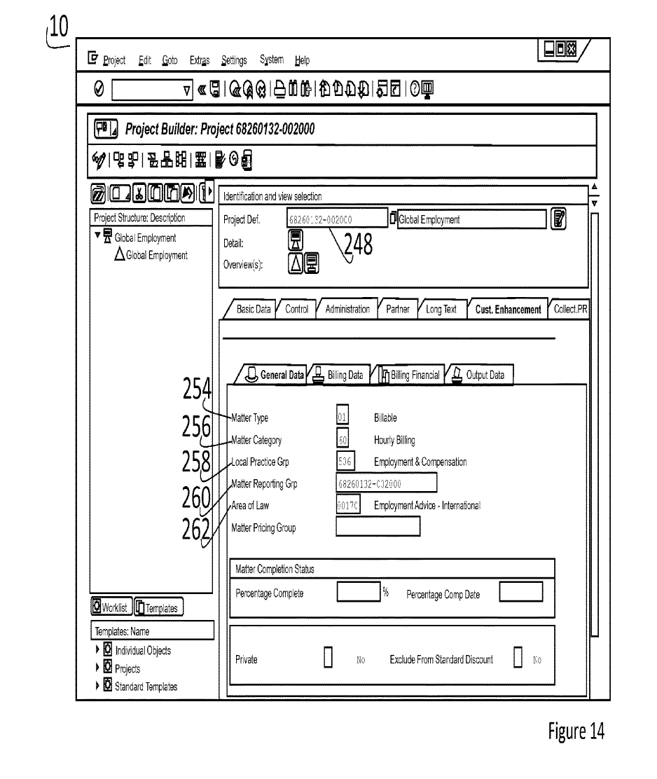

FIG. 14 illustrates an additional screen shot of Billing and Collections system 10 wherein the following is displayed: matter type field 254, matter category field 256, local practice group field 258, matter reporting group field 260, and area of law field 262. The matter type field 254 indicates if the matter is billable or non-billable, or if the system is to hold billing or if the work is pro bono in nature. The matter category field 256 indicates whether the billing is: hourly, fixed fee or flat rate, custom flat fee or traditional flat fee. Other fields indicate whether the matter is a dunning communications and accounting statements to the client.

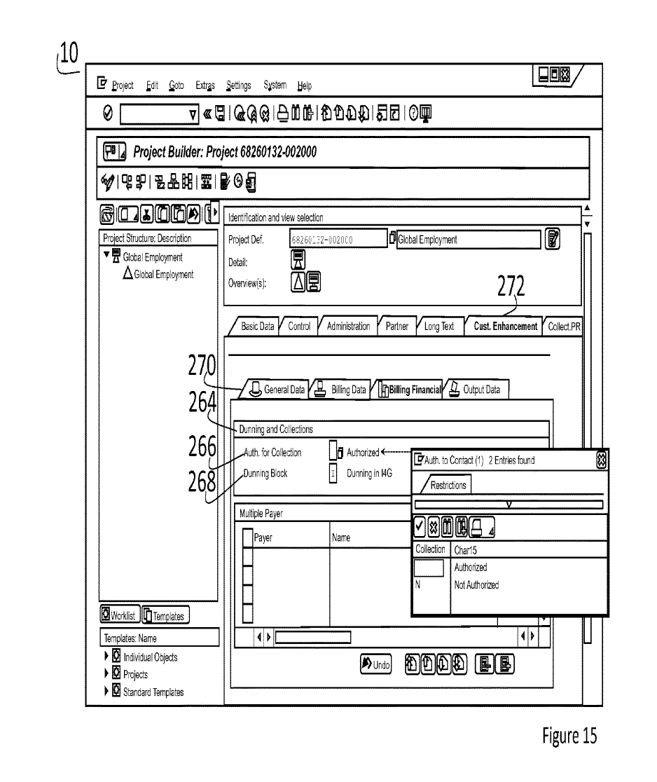

FIG. 15 illustrates an additional screen shot of Billing and Collections System 10 wherein the following is displayed: customer enhancement tab 272 which allows the user to select a general data tab 270 and from that a dunning and collections box 264 containing the following fields: authorized for collections field 266 and a dunning block indicator field 268. If the matter is authorized for collections, it will be placed in the automated collections system which reminds the client at various preselected intervals to make a payment, e.g., after 10 days an email, after 20 days a letter and after 30 days late a phone call asking for a promise to pay. The system will then keep track of the number of times that the client has agreed to pay but did not send payment. Once a certain number has been reached, the matter may be sent to credit reporting and/or the litigation department of that or another firm.

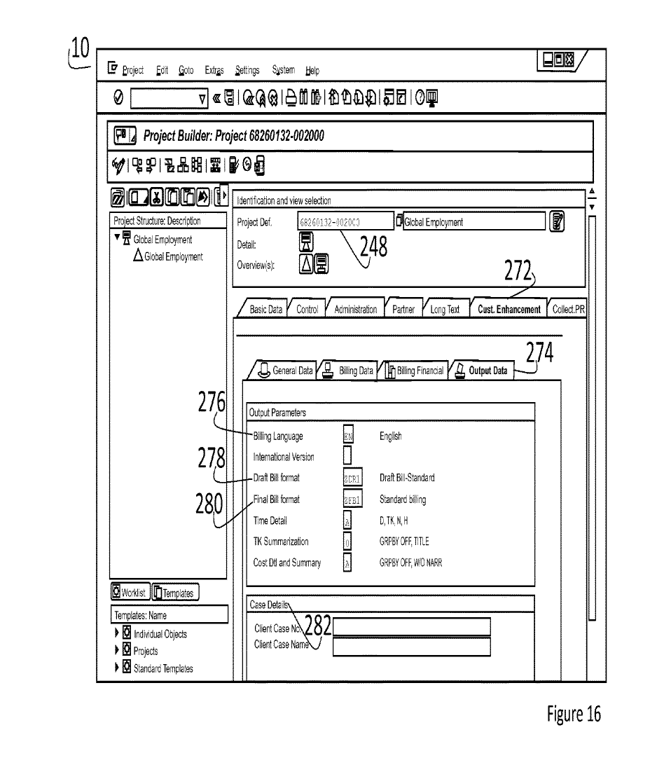

FIG. 16 shows a screen shot of Billing and Collections System 10 which shows the project definition field 248 which will bring up the customer enhancement tab 272 which in turn brings up the output data selection tab 274 which shows the following fields: billing language 276, draft bill format 278, final bill format 280 and the client case detail fields 282 where the System 10 will track the client case number and name. The draft and final bill formats can be selected from a plurality of templates provided to the user thereof, all of which may be further customized by the user.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. A computer implemented billing and collections system comprising:
at least one processor;
a user interface comprising a data entry screen configured to receive a plurality of payment options:
a client trust account database for storing said plurality of payment options;
an accounts receivable database for storing said plurality of payment options; and
a server comprising a processor and non-transitory storage medium for storing instructions that, when executed by a processor, perform the following:
receive, by the computing device over a communication network, said plurality of payment options, associated with a client executing a financial transaction, wherein said plurality of payment options is matched with said client's account:
store client information from said plurality of payment options;
perform analysis of accounting information associated with the plurality of payment options of said client, wherein said plurality of payment options are transferred to said client trust account database or accounts receivable database, based according to said analysis; and
allocate at least a partial payment from said plurality of payment options, wherein said partial payment is allocated according to predetermined allocation rules.

2. The billing and collections system of claim 1, wherein said client information includes at least one of the following: client address, client phone number, bank name, bank address, bank routing number, bank account number, and invoice date.

3. The billing and collections system of claim 1, wherein said plurality of payment options are compared to the invoice date and automatically transferred to said accounts receivable database after a predetermined number of days have passed between said invoice date and date of receipt of at least one of said plurality of payment options.

4. (canceled)

5. (canceled)

6. The billing and collections system of claim 1, further comprising means to provide discount incentives from at least one of the following: early payment, payment within a certain number of days from invoice date, entering into a payment arrangements over a set period of time and making immediate payments.

7. The billing and collections system of claim 1, wherein said plurality of payment options are matched to said client, according to one or more of the following: client name, client address, bank name, bank address, bank routing number, bank account number, invoice date, matter number, billing office ID, and billing partner ID.

8. The billing and collections system of claim 1, further comprising a payment reminder, automatically sent to said client, according to client's preselected preference of communication, after a predetermined number of days have passed since the invoice was generated and payment has not been received.

9. (canceled)

10. (canceled)

11. The billing and collections system of claim 1, further comprising security levels wherein said client accounting information and said client information is accessed according to said security level, wherein billing or client-originating partner associated with said client determine said security level.

12. The billing and collections system of claim 11, wherein said security level is based on confidentiality status of said client, defined by said billing or client-originating partner associated with said client, wherein said security levels determine access to said client information and said client accounting information, and the means in which said client is contacted, wherein at least one of the following is selected, according to position, title, office, or practice area, to access said accounting information: billing partner, client-originating partner, secretary, and staff.

13. (canceled)

14. (canceled)

15. (canceled)

16. (canceled)

17. (canceled)

18. (canceled)

19. (canceled)

20. (canceled)

21. (canceled)

22. (canceled)

23. The billing and collections system of claim 1, wherein said accounting information comprises dunning information, payment history information, and billing information.

24. The billing and collections system of claim 23, wherein said accounting information conveys outstanding balance for said client, in which said plurality of payment options are automatically transferred to said accounts receivable database.

25. The billing and collections system of claim 23, wherein said accounting information conveys invoice has not been generated for said client, in which said plurality of payment options are automatically transferred to said client trust account database.

26. The billing and collections system of claim 1, wherein said plurality of payment options include processing receipts for at least one of the following: cash deposit, credit card transaction, debit card transaction, check deposit, money order, bank record of deposit, e-money orders, and electronic transfer funds.

27. The billing and collections system of claim 1, wherein said financial transaction is determined by said client preference, wherein plurality of payment options are transmitted in accordance with one of the following options:
full amount of said plurality of payment options is disbursed against multiple bills;
full amount of said plurality of payment options is applied to a final bill;
partial amount of said plurality of payment options is applied to a bill;
said plurality of payment options is applied to an interim bill; and
full amount of said plurality of payment options is applied to a bill and any remaining amount is classified as an unallocated credit and is allocated to a general ledger account.

28. The billing and collections system of claim 26, wherein said plurality of payment options are stored in a different currency from the bank account currency standard.

29. The billing and collections system of claim 1, wherein predetermined partial allocation rules are set in accordance with the tax laws of the respective jurisdiction wherein the billing partner or client originating partner's place of business is located, wherein said plurality of payment options are allocated according to: taxes, hard costs, soft costs, and fees.

30. The billing and collections system of claim 1, further comprising:
analyze said financial transaction associated with said client;
categorize said client as consumer, if said financial transaction is entirely consumer based or categorize said client as business, if said financial transaction is entirely business based;
dun said client according to dunning regulations based according to said categorization.

31. The billing and collections system of claim 1, further comprising:
analyze said accounts receivable database; and
generate a list of clients that meet requirements for a payment option, which comprises periodic payments for larger bills.

32. A billing and collections method, said method being designed to be run on a computerized platform and comprising the steps of:
receiving a plurality of payment options, associated with a client executing a financial transaction, wherein said plurality of payment options are matched with said client's account;
storing client information from said plurality of payment options;
analyzing accounting information associated with the plurality of payment options of said client;
transferring said plurality of payment options to said client trust account database or accounts receivable database, based according to said analysis; and
allocating at least a partial payment from said plurality of payment options, wherein said partial payment is allocated according to predetermined partial allocation rules.

33. The business and collections method of claim 32, further comprising the step of:
defining security levels that designate range of access to said client information and said accounting information of said client; and
regulating the range of access when viewing said information associated with said client, according to said client's confidentiality status, wherein billing partner or client originating partner designate security level.

34. The business and collections method of claim 32, further comprising an automatic reminder process, wherein the automatic reminder process automatically reminds said client, after a predetermined number of days have passed since the invoice was generated, payment has not been received.

35. The business and collections method of claim 32, further comprising the step of:
matching said bank record of deposit with a client's account;
automatically reconciling said bank record of deposit with a general ledger, bank ledger, or master database; and
flagging any incorrect or missing client information.

36. The business and collections method of claim 32, further comprising the step of:
analyzing said accounts receivable database; and
generating a list of clients that meet requirements for a payment option, which comprises periodic payments for larger bills.

37. The business and collections method of claim 32, further comprising the step of:
analyzing said financial transaction associated with said client;
categorizing said client as consumer, if said financial transaction is entirely consumer based or categorizing said client as business, if said financial transaction is entirely business based;
dunning said client according to dunning regulations based according to said categorization.
